(19) United States
(12) Patent Application Publication
(10) Pub. No.: US 2026/0270231 A1
(43) Pub. Date: Sep. 10, 2026

(54) REDUNDANT ALIAS MANAGEMENT

(71) Applicant: Yokogawa Electric Corporation, TOKYO (JP)

(72) Inventors: Patrick Clay, Frisco, TX (US); Vien Nguyen, Frisco, TX (US); Andrew Keller, Lewisville, TX (US); Rabi Gurung, Calgary, CA (US)

(21) Appl. No.: 19/073,488

(22) Filed: Mar. 7, 2025

(51) Int. Cl. H04L 61/3015; H04L 67/12

(52) U.S. Cl. CPC H04L 61/3015; H04L 67/12

(57) ABSTRACT

Various implementations described herein relate to managing redundant aliases. In various implementations, an alias registered to multiple nodes of a process automation facility may be identified, each node including a sensor or actuator. The method includes using the alias, concurrently subscribing to first and second nodes of the multiple nodes. While concurrently subscribed to both the first and second nodes, and while a first criterion is satisfied, the method includes exchanging data with the first and second nodes. The method further includes, based on the data exchanged with the first node, contributing to a process control loop of the process automation facility. The method further includes disregarding data received from the second node. Upon determining that the first criterion is no longer satisfied or that a second criterion is satisfied, the method includes exchanging data with at least the second node. The method further includes, based on the data exchanged with the second node, contributing to the same process control loop or a different process control loop of the process automation facility.

### BACKGROUND

Process automation facilities may include myriad sensors, actuators, and distributed control nodes (DCNs), among other components. In some cases, the DCNs host cross-platform servers such as Open Platform Communications Unified Architecture (OPC UA) servers with standardized interfaces that allow client applications (e.g., cross platform clients such as OPC UA clients, function blocks, etc.) to read and/or write to the sensors' and actuators' input/output (I/O) channels or signals. The location or path to an I/O signal in an OPC UA server is a node ID. Tracking these I/O signals using traditional OPC UA node IDs may present various challenges. Connection strings (e.g., IP addresses, including TCP ports) of individual OPC UA servers, as well as node IDs in the server used to identify individual components that are accessible via those nodes, are not readily-interpretable by humans. The OPC UA standard implements a Global Discovery Server (GDS) that provides an “Alias Name Management Service” (ANMS) that facilitates the mapping of aliases (strings of characters that are human-readable/meaningful) to OPC UA server connection strings and node IDs representing instances of variables (I/O signals) or objects (function blocks) on the server. In other words, the GDS can act like a “phone book” for OPC UA clients. An OPC UA client/server at various times will connect to the GDS and retrieve a list of aliases (structured data of alias name, IP address of the server, node ID inside that server). After retrieving this list of aliases, the OPC UA client/server will disconnect from the GDS, and use the alias information to communicate with one or more signals or function blocks (e.g., actuators, sensors, compute nodes, function blocks) associated with the aliases.

When migrating an alias from one OPC UA server to another, there can be an interruption in data to a connected OPC UA client, because the client needs to disconnect from the OPC UA server the alias was previously assigned to and connect and subscribe to the new OPC UA server and node that the alias is currently assigned to.

Currently, OPC UA clients/servers obtain updated alias information by continuously/periodically polling the GDS using persistent connections such as a Transmission Control Protocol (TCP) connection. However, if an alias is migrated from one OPC UA server to another, a OPC UA client who subscribed to that alias may experience an interruption in service while the OPC UA client discovers the migration (e.g., by consulting with the GDS), disconnecting from the “old” OPC UA server and connecting to the “new” OPC UA server. Such a service interruption may be highly problematic in a process automation facility where many process control loops operate at relatively high-frequencies and/or are expected to be responsive with minimal latency.

### SUMMARY

Implementations are described herein for using duplicate aliases to reduce or eliminate gaps in communication that arise from an alias being migrated from one node of one DCN to another node of the same DCN or a different DCN. More particularly, but not exclusively, techniques described herein relate to allowing a cross-platform application such as a OPC UA server to register, with an alias server such as a GDS, one or more redundant aliases. Suppose the alias “Acme123” is already registered by a server A to a particular sensor, but is to be migrated to a new sensor hosted by server B. The DCN server B (and the new sensor) can register “Acme123” to the new sensor, even while “Acme123” remains simultaneously registered by server A with the old sensor. A subscribing client, such as an OPC UA client, may at least temporarily establish a concurrent connection/subscription to the I/O node on both server A and server B using the same alias, “Acme 123.” After the redundant connection/subscription is established, server A can be disconnected and the aliases associated with server A are removed from the GDS during the unregistration process. The OPC UA client can then transition from ignoring data change notifications from server B to using data change notifications from server B as the primary source of data for the alias, with little to no interruption in service.

### BRIEF DESCRIPTION OF THE DRAWINGS

FIG. 1 shows an example environment including a process automation management system, a process automation network, and multiple distributed control nodes.

FIG. 2 is a sequence diagram demonstration an example of alias migration using the present technology, resulting in a seamless transition.

FIG. 3 schematically depicts an example method for practicing selected aspects of the present disclosure.

FIG. 4 shows a block diagram of an example computing device that may be used to implement various aspects of the disclosure.

### DETAILED DESCRIPTION

Implementations are described herein for using duplicate aliases to reduce or eliminate gaps in communication that arise from I/O signals being migrated from one node of one OPC UA server to another node of the same OPC UA server or a different OPC UA server. More particularly, but not exclusively, techniques described herein relate to allowing a cross-platform application such as a OPC UA server to register, with an alias management server such as a GDS, one or more redundant aliases. Suppose the alias “Acme123” is already registered by a server A to a particular sensor, but is to be migrated to a new sensor hosted by server B. The server B (and the new sensor) can register “Acme123” to the new sensor, even while “Acme123” remains simultaneously registered by server A with the old sensor. A subscribing client, such as an OPC UA client, may at least temporarily establish a concurrent connection/subscription to both server A and server B using the same alias, “Acme 123.” After the redundant connection/subscription is established, server A can unregister the alias from the GDS. The OPC UA client can then transition from ignoring data change notifications from server B to using data change notifications from server B as the primary source of data for the alias, with little to no interruption in service.

Put slightly differently, some implementations of the disclosure address data interruption in process automation environments (e.g., including OPC UA environments) during alias migration between servers. Various techniques rely on the use of redundant aliases: when an alias migrates from server A to server B, server B registers the same alias with the GDS while server A's registration remains active. An OPC UA client concurrently subscribes to both, initially ignoring data from server B. After this duplicate subscription, server A unregisters the alias, and the client seamlessly switches to server B, preventing service interruption. This is particularly beneficial for high-frequency process control loops. This approach can be extended to multiple servers, creating a chain of redundant aliases for increased resilience. Implementation options include client-side management of concurrent subscriptions or a server-side approach pre-configuring redundant aliases for immediate failover.

As used herein, a “cross-platform” client refers to a client such as an OPC UA client that is capable of communicating (e.g., via a network connection) with server(s) using a hardware-agnostic protocol, such as OPC UA. Similarly, a “cross-platform” server refers to a server such as an OPC UA server that is capable of communicating (e.g., via a network connection) with client(s) using a hardware-agnostic protocol, such as OPC UA. As noted herein, an “alias” refers to a human-readable or human-interpretable (at least relative to a raw connection string) string of one or more characters, such as a string of characters used to identify a particular node of a DCN (e.g., a sensor, actuator, function block).

Some implementations disclosed herein are directed to identifying an alias registered to multiple nodes of a process automation facility, each node comprising a sensor or actuator. Using the alias, the implementations concurrently subscribe a client to first and second nodes of the multiple nodes. While concurrently subscribed to both the first and second nodes, and while a first criterion is satisfied, data is exchanged with the first and second nodes. Based on the data exchanged with the first node, the client may contribute to a process control loop of the process automation facility, while disregarding data received from the second node. Upon determining that the first criterion is no longer satisfied or that a second criterion is satisfied, the client may exchange data with at least the second node, and based on the data exchanged with the second node, contribute to the same process control loop or a different process control loop of the process automation facility.

Implementations disclosed herein can mitigate (e.g., eliminate) various drawbacks with current techniques. For example, the use of duplicate aliases allows for concurrent subscriptions to both the old and new locations of a migrated alias, ensuring continuous data flow to the client even during the migration process. As another example, the ability to temporarily ignore data from the new alias location until the old alias is unregistered prevents conflicts and ensures a seamless transition. As another example, the system can be extended to support multiple redundant aliases, creating a chain of backup data sources for even greater resilience against service interruptions.

As a non-limiting example of some implementations disclosed herein, consider a large chemical plant with numerous sensors and actuators across multiple DCNs, all registered with a GDS using human-readable aliases. If a technician replaces a faulty temperature sensor, the GDS detects the change in the connection string associated with the sensor's alias. The OPC UA client concurrently subscribes to both the old and new sensor using this alias, initially ignoring data from the new sensor. Once the duplicate subscription is established, the old sensor's registration is removed from the GDS, and the client seamlessly transitions to using data from the new sensor, ensuring continuous data flow without interruption to the process control loop.

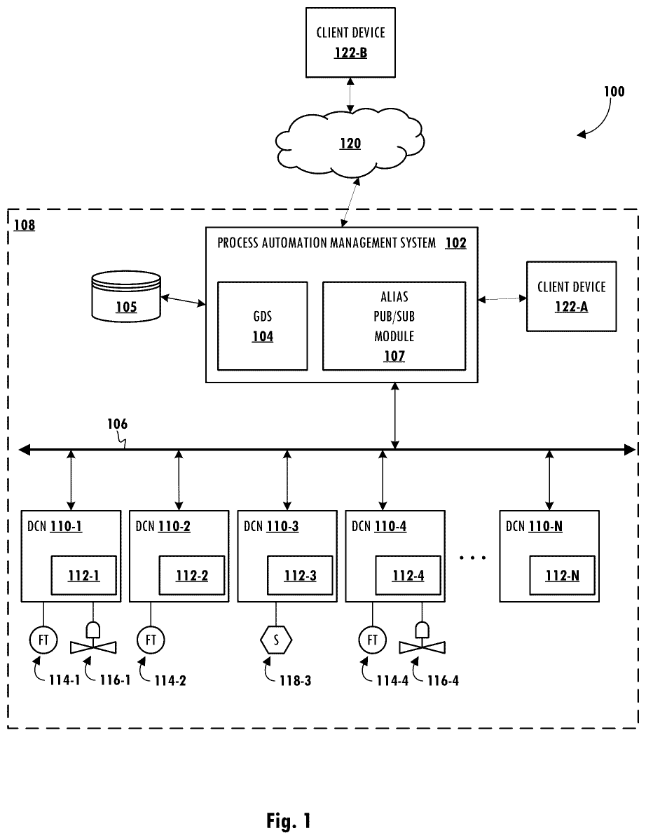

Referring now to FIG. 1, an example environment 100 in which various aspects of the present disclosure may be implemented is depicted schematically. A process automation management system 102 is operably coupled with a process automation network in a process automation facility 108. Process automation facility 108 may take numerous forms and may be designed to implement any number of at least partially automated processes. For example, process automation facility 108 may take the form of a chemical processing plant, an oil or natural gas refinery, a catalyst factory, a manufacturing facility, a pharmaceutical manufacturing facility, an offshore oil platform, etc.

Process automation network 106 may be implemented using various wired and/or wireless communication technologies. Process automation is often employed in scenarios in which the cost of failure tends to be large, both in human safety and financial cost to stakeholders. Accordingly, in various implementations, process automation network 106 may be configured with redundancies and/or backups to provide high availability (HA) and/or high quality of service (QoS).

In various implementations, process automation network 106 may include one or more networks based on the Institute of Electrical and Electronics Engineers (IEEE) 802.3 standard, such as Gigabit Ethernet and/or 10-Gigabit Ethernet. Process automation network 106 may also, or instead, include one or more networks based on the IEEE 802.11 (Wi-Fi) and/or IEEE 802.16 (WiMAX) standards. Process automation network 106 may also, or instead, include one or more networks based on the IEEE 802.20 standard, commonly referred to as “Mobile Broadband Wireless Access.” Process automation network 106 may also, or instead, include one or more networks based on the 3rd Generation Partnership Project (3GPP) Long Term Evolution (LTE) and/or 4G standard protocols. Process automation network 106 may also, or instead, include one or more wired and/or wireless proprietary networks; one or more wired and/or wireless local area networks (LANs), such as an IEEE 802.11 network; and/or one or more wired and/or wireless wide area networks (WANs), such as a cellular data network and/or the Internet. Process automation network 106 may also, or instead, include one or more machine-to-machine networks.

Components of FIG. 1 may additionally or alternatively be implemented on a mesh network, offering several advantages. A mesh network's distributed architecture can enhance resilience against single points of failure, ensuring continued operation even if some network nodes become unavailable. Furthermore, distributing the GDS across multiple nodes in a mesh network can reduce latency by minimizing the distance data must travel, leading to faster response times for OPC UA clients. The inherent redundancy of a mesh network can also improve the overall reliability and scalability of the alias management system.

Process automation system 102 may include a GDS 104, an optional alias publication-subscribe (pub/sub) module 107, and a database 105 that stores information used by GDS 104 and/or alias pub/sub module 107 to practice selected aspects of the present disclosure. Various aspects of process automation management system 102, such as GDS 104 and/or alias pub/sub module 107, may be implemented using any combination of hardware and software. In some implementations, process automation management system 102 may be implemented across multiple computer systems as part of what is often referred to as a “cloud infrastructure” or simply the “cloud.” However, this is not required, and in FIG. 1, for instance, process automation management system 102 is implemented within process automation facility 108, e.g., in a single building or across a single campus of buildings or other industrial infrastructure. In such an implementation, process automation management system 102 may be implemented on one or more local computing systems, such as on one or more server computers.

In addition to process automation management system 102, a variety of other nodes are operably coupled with process automation network 106. In FIG. 1, for instance, N (positive integer) DCNs 110-1 to 110-N are operably coupled with process automation network 106. Each DCN may include circuitry or logic 112 that may take various forms, such as processor(s) that execute instructions in memory, a field-programmable gate array (FPGA), an application-specific integrated circuit (ASIC), and so forth. Each DCN 110 may have a particular role to play in process automation network 106. “Compute” DCNs may, for instance, control a process loop (e.g., a chemical process loop) in which various “field” devices (e.g., devices having sensors and/or actuators) interface with each other to perform some number of function control blocks (FBs).

While not depicted in FIG. 1, in various implementations, each DCN may execute a cross-platform server that orchestrates access to the DCN's constituent I/O channels. In some cases, this cross-platform server may take the form of an OPC UA server. Additionally or alternatively, each DCN may operate a cross-platform client that is configured to subscribe to I/O channels (e.g., made accessible by the aforementioned cross-platform server) in order to receive information needed for the DCN to perform some function. In some cases, this cross-platform client may take the form of an OPC UA client.

Each DCN 110 may have various I/O components, which are accessible as “channels,” and which dictate at least some of its operational technology (OT) capabilities and, more generally, its role at process automation facility 108. For example, first DCN 110-1 includes a flow transmitter (FT) component 114-1 and an actuator (e.g., a valve) 116-1. In some implementations, a software component (e.g., a function block) implemented on DCN 110-1 (or any other DCN mentioned herein) may transform an analog signal to digital; and/or convert the signal between different units of measurement, for instance.

In addition, in some implementations, a software component (e.g., a function block) implemented on DCN 110-1 may be configured to translate data between various protocols. For example, a particular vendor's DCN (or other legacy device) may not be configured natively to communicate data using the OPC UA. In some such implementations, another DCN 110 may be deployed to translate this data from the vendor's proprietary format to OPC UA. Some such DCNs 110 may be referred to as “gateways” or “bridges” because they form a link between legacy technology and standards such as OPC UA.

Actuator 116-1 (and other actuators described herein) may be any electric, hydraulic, mechanical, and/or pneumatic component that is controllable to affect some aspect of a process automation workflow that occurs at process automation facility 108. In many cases, an actuator 116 may perform its function in response to various signals, such as sensor signals or commands from compute DCNs (which themselves may monitor for sensor signals). Some non-limiting examples of actuators 116 include, but are not limited to, valves, pistons, rotors, switches, heaters, coolers, stirrers, injectors, devices to create vacuums, belts, tracks, gears, grippers, motors, relays, servomechanisms, etc.

Each DCN 110 may have different OT capabilities with respect to one or more (e.g., all) other DCNs 110. In FIG. 1, for instance, second DCN 110-2 includes an FT component 114-2 but no actuator. Third DCN 110-3 includes a sensor 118-3 but no actuator. Sensor 118-3 (and elsewhere herein) may take various forms, including but not limited to a pressure sensor, a temperature sensor, a flow sensor (e.g., FT component 114), various types of proximity sensors, a light sensor (e.g., a photodiode), a pressure wave sensor (e.g., microphone), a humidity sensor (e.g., a humistor), a radiation dosimeter, a laser absorption spectrograph (e.g., a multi-pass optical cell), and so forth. Like first DCN 110-1, fourth DCN 110-4 also includes both an FT component 114-4 and an actuator 116-4.

Unlike DCNs 110-1 to 110-4, DCN 110-N does not include any input/output (actuators or sensors) components. Instead, DCN 110-N may be a “compute only” DCN whose role is to facilitate cooperation between itself and one or more other DCNs 110 on process automation network 106 to implement an at least partially automated process. For example, DCN 110-N may control a single process loop (e.g., a chemical process control loop) that involves one or more other DCNs 110. In some cases, a compute DCN 110 may perform a role similar to an autopilot on an airplane—the compute DCN 110 may receive various signals and, based on those signals and various criteria and/or thresholds, control various actuators. For example, the compute DCN 110 may monitor various sensors 118 to ascertain data about chemical levels, flow rates (e.g., across valves), tank temperatures, control rates, etc., and may control one or more actuators 116 based on these data and/or comparisons of these data to various criteria and/or thresholds. For instance, compute DCN 110-N can control actuator 116-4 by transmitting, to DCN 110-4, corresponding command(s) that can optionally conform to a protocol that is specific to DCN 110-4.

Many DCNs may host multiple resources such as physical I/O components and/or function blocks. Consequently, these DCNs may include multiple I/O channels and/or function blocks that can be accessed, e.g., by other devices or systems such as other DCNs, GDS 104, alias pub/sub module 107, etc. For example, each DCN 110 may host a cross-platform server, such as an OPC UA server, that provides access to various resources hosted by the DCN 110, including the DCN's I/O channels and/or function blocks. A cross-platform client application, such as an OPC UA client operating on a DCN 110, may connect to a cross-platform server hosted by the DCN so that it can read data from input channels associated with, for instance, sensors such as FT components 114, sensors 118, function blocks, etc. Likewise, the client application may connect to the server hosted by the DCN to write data to output channels, e.g., to provide control signals or commands to actuators 116.

As noted above, tracking the myriad data sources (e.g., I/O channels and/or other data sources such as function blocks) of DCNs deployed across a complex process automation facility 108 using typical connection strings (e.g., networking information plus node IDs) may present various challenges. Connection strings of individual nodes, which may include Internet Protocol (IP) addresses and/or Transmission Control Protocol (TCP) ports, as well as node IDs used to identify individual components that are accessible via those nodes, are not readily interpretable by or meaningful to humans, and do not easily scale. Hence, GDS 104 is used to assign human-interpretable and/or meaningful aliases to the various data sources made available by the DCNs.

As an example, an OPC UA server executing on a DCN 110 may be reachable, e.g., by an OPC UA client, using the following networking information:
opc.tcp://10.0.1.1:4840

The characters “opc.tcp” specify a connection protocol to be used. The numbers “10.0.1.1” may be an IP address of the DCN executing the OPC UA server. The numbers “4840” may be the TCP port to which the OPC UA server is listening and accepting connections. This OPC UA server may in turn provide access to multiple data sources, such as I/O channels or other pieces of data (e.g., sensor readings stored in memory, results of calculations, semaphore values, etc.). Each of these individual data sources may be referenced using a Node ID, such as:
ns=5; I=5242

An OPC UA client, and by extension, a person controlling it, may need to know both these unintuitive and/or cryptic values in order to access the particular data source.

Accordingly, OPC UA servers executing on DCNs can register aliases to GDS 104 using an Alias Name Management Service (ANMS). This allows an alias to be created that maps a human-interpretable alias (e.g., “MyAlias1”) to the connection string set forth above. In other words, an alias identifies, for OPC UA clients, which OPC UA server, and where on that OPC UA server, a particular data source can be accessed. Later, an OPC UA client seeking to access the data source may query GDS 104 using an alias (e.g., “MyAlias1”). GDS 104 may respond by providing networking information including the corresponding connection string. The OPC UA client can then use this connection string to establish a connection to the corresponding OPC UA server, and read data from and/or write data (e.g., control signals or commands) to the data source.

Techniques described herein may be applied to components of FIG. 1 to address the data interruption issue during alias migration. For example, consider an alias “TempSensor1” initially registered to sensor 118-3 on DCN 110-3 (the first node). A new sensor (the second node) replaces the old one, and its alias is registered to a new location on DCN 110-4. In various implementations, an OPC UA client (not depicted) concurrently subscribes to both sensor 118-3 on DCN 110-3 and the new sensor on DCN 110-4, initially using data from the first node (118-3) while disregarding data from the second node. Once the first criterion (e.g., the old sensor remaining registered) is no longer satisfied (e.g., the alias is deregistered from 118-3), or a second criterion is met (e.g., the alias migration is complete), the client seamlessly transitions to using data from the new sensor on DCN 110-4, preventing service interruption. The process automation management system 102 facilitates this by managing the alias registrations of the GDS 104 and database 105.

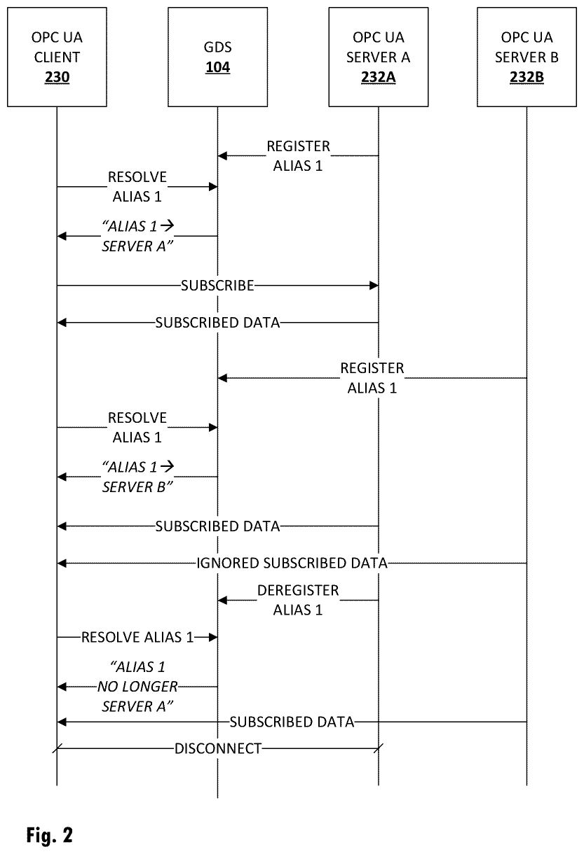

FIG. 2 is a sequence diagram that demonstrates an example of how selected aspects of the present disclosure may be implemented. In FIG. 2, time runs down the page. Starting at top, a first OPC UA server 232A registers an alias “Alias 1” with GDS 104. For example, the first OPC UA server 232A could be executing on a first DCN and registering the alias “Alias1” to GDS 104 for access to a first data source at that first DCN (e.g., a first OPC UA sensor). In some cases, registering the alias may include sending a server connection string such as “opsc.tcp://10.0.1.1:4840” and/or a node ID such as “ns=5; i=5242.” to GDS 104.

Sometime later, an OPC UA client 230 executing on a DCN (not depicted, see FIG. 1) that wishes to subscribe to the sensor registered to “Alias 1” communicates with GDS 104 over one or more networks (e.g., process automation network 106) to resolve “Alias 1” to a connection string that is usable by OPC UA client 230 to connect to a server such as first OPC UA server 232A. For example, an OPC UA client 230 may connect to a GDS 104 over one or more networks, and receive, from GDS 104 (as shown in FIG. 2), a server connection string such as “opsc.tcp://10.0.1.1:4840” and a node ID such as “ns=5; i=5242.”. OPC UA client 230 may then subscribe to the sensor registered to “Alias 1” using these connection strings and/or node IDs, and may thereafter receive subscribed data, as shown in FIG. 2.

Sometime later, a second OPC UA server 232B connects to GDS 104 and registers “Alias 1” to a different connection string, such as “opc.tcp://10.0.2.1:4841” and/or a different node ID, such as “ns=6; i=5243.” OPC UA client 230 may once again (e.g., as part of a scheduled or periodic alias polling routine, or in response to an alias update message from pub/sub module 107) connect to GDS 104 to resolve “Alias 1” to one or more new connection strings and node IDs that are usable by OPC UA client 230 to connect to second OPC UA server 232B. For example, an OPC UA client 230 may connect to a GDS 104 over one or more networks, and receive, from GDS 104 (as shown in FIG. 2), a server connection string such as “opc.tcp://10.0.2.1:4841” and a node ID such as “ns=6; i=5243.”. OPC UA client 230 may then subscribe to the new sensor registered to “Alias 1” using these connection strings and/or node IDs, such that at least temporarily, OPC UA client 230 is subscribed concurrently to two different nodes registered to “Alias 1”, namely, the “old” node hosted by first OPC UA server 232A and the “new” node hosted by second OPC UA server 232B.

OPC UA client 230 may thereafter receive subscribed data from both of these nodes. As shown in FIG. 2, while concurrently subscribed to both nodes, OPC UA client 230 may at least temporarily—e.g., while a first criterion is satisfied or until a second criterion is satisfied—ignore subscribed-to data it receives from second OPC UA server 232B. The first criterion may include, for instance, first OPC UA server 232A being subscribed to prior to second OPC UA server 232B, first OPC UA server 232A being assigned a higher priority than second OPC UA server 232B, “Alias 1” remaining registered to first OPC UA server 232A, etc. The second criterion may include, for instance, a halt in data received from first OPC UA server 232A, a degradation in data quality of data received from first OPC UA server 232A, a degradation of a network connection with OPC UA server 232A, a determination that “Alias 1” has been migrated from first OPC UA server 232A to second OPC UA server 232B, an/or a determination that “Alias 1” has been deregistered by GDS 104.

In some implementations, the second criterion may be that the new node to which the alias is being migrated satisfy one or more performance metrics. For example, the second criterion may be that the performance metrics demonstrate that the new node is currently stable and reliable, has a high uptime, has a very low latency, and/or provides consistent and secure data. For example, a new sensor's data quality (e.g., signal-to-noise ratio, accuracy, and consistency) may be required to meet predefined thresholds for a specified duration (e.g., 10 minutes) before the cross-platform client starts using data exclusively from the new sensor. This ensures the new sensor is reliable before switching over.

In FIG. 2, first OPC UA server 232A deregisters “Alias 1” from GDS 104. Later, OPC UA client 230 reconnects to GDS (e.g., automatically or in response to an alias update broadcast by GDS 104 and/or pub/sub module 107) to resolve “Alias 1” to a new connection string and/or node ID. This time, GDS 104 either formulates an explicit message that “Alias 1” is no longer registered to first OPC UA server 232A or implicitly communicates the same information by indicating that only the node of second OPC UA server 232B is now registered to “Alias 1.” Thereafter, OPC UA client 230 receives the subscribed-to data from second OPC UA server 232B exclusively, rather than from both first OPC UA server 232A and second OPC UA server 232B.

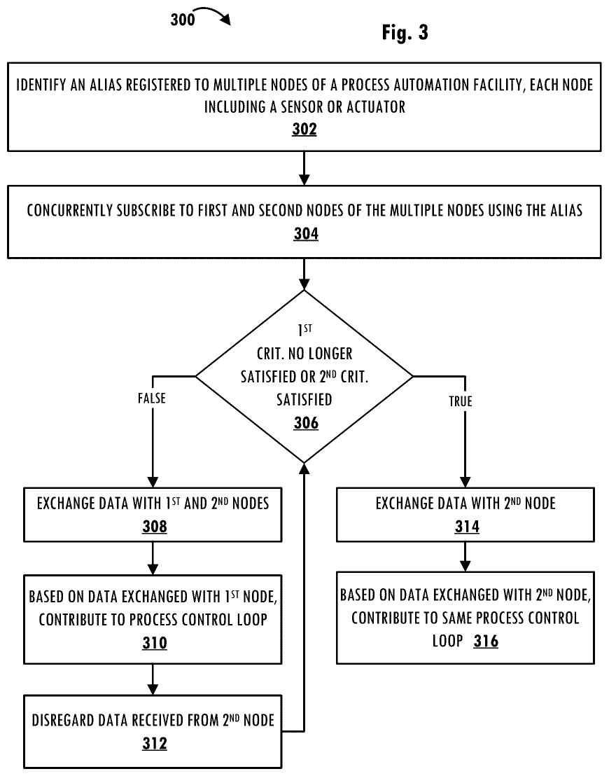

FIG. 3 schematically depicts a method 300 for practicing selected aspects of the present disclosure. For convenience, the operations of the flow chart are described with reference to a system that performs the operations. This system may include various components of various computer systems and/or process automation nodes, such as those depicted in FIGS. 1 and 2, described above. Moreover, while operations of method 300 are shown in a particular order, this is not meant to be limiting. One or more operations may be reordered, omitted or added.

At block 302, the system, e.g., by way of a cross-platform client (e.g., an OPC UA client), may identify an alias registered to multiple nodes of a process automation facility, each node including a sensor or actuator, such as those depicted in FIG. 1 (118-3, 116-1, 114-1, etc.).

At block 304, the system, e.g., by way of the cross-platform client, may concurrently subscribe to first and second nodes of the multiple nodes using the alias, for instance, subscribing to an old sensor (first node) and a new sensor (second node) using the alias “TempSensor1” as described previously.

At block 306, the system, e.g., by way of the cross-platform client, may determine whether a first criterion continues to be satisfied and/or whether a second criterion is satisfied. The first criterion may be, for instance, that the first node was subscribed to prior to the second node (e.g., prioritizing data from a sensor that has been operating reliably for a longer duration), or that the first node has a higher priority than the second node (e.g., a higher-accuracy sensor might be prioritized), or that the alias remains registered to the first node (the system might continue using data from the old sensor until it's explicitly deregistered). The second criterion may or may not mirror these first criteria in some cases and may include, for instance, a halt in data received from the first node (e.g., the old sensor malfunctioning), a degradation in data quality (e.g., the old sensor producing increasingly noisy data), a degradation of the network connection (e.g., a network outage affecting the old sensor), the alias having migrated from the first to the second node (reflecting the completion of the alias migration), or the alias having been deregistered by an alias server (e.g., the old sensor being removed from service or repurposed elsewhere).

If the first criterion remains satisfied and/or the second criterion remains unsatisfied, method 300 may proceed to block 308. At block 308, the system, e.g., by way of the cross-platform client, may exchange data with both the first and second nodes, at least temporarily. Based on the data exchanged with the first node during this time, at block 310, the cross-platform client may contribute to a process control loop of the process automation facility. For example, the cross-platform client may continue to operate an actuator or output computational results based data retrieved from the old sensor. Meanwhile, at block 312, the cross-platform client may disregard data received from the second node. Method 300 may then proceed back to block 306.

If it is determined at block 306 that the first criterion is no longer satisfied and/or that the second criterion is now satisfied, then method 300 may proceed to block 314. At block 314, the cross-platform client may exchange data with the second node. At block 316, the data exchanged with the second node may be used to contribute to the same process control loop or a different process control loop, such as those shown in FIG. 1. For example, if the first and second nodes are sensors, and contributing to the process control loop involves operating actuators based on sensor signals, then the system may switch to using the second sensor's data to control the actuators.

As one non-limiting example of how techniques described herein may be implemented, consider a slurry pipeline in an oil refinery where the temperature sensor on a crucial valve (“Acme123”) needs replacing. The old valve's temperature sensor (server A) is connected via alias “Acme123,” and a new sensor (server B) with the same alias is installed. Server B registers “Acme123” with the GDS, creating a duplicate entry. The OPC UA client concurrently subscribes to both server A and server B, initially ignoring data from the new sensor. Once the connection to server B is confirmed and the temperature data is validated, server A unregisters “Acme123,” and the client seamlessly switches to the new sensor's data, maintaining continuous monitoring of the slurry temperature despite the valve's hardware upgrade.

As another non-limiting example of some implementations disclosed herein, consider a pressure sensor on a subsea wellhead on an offshore drilling platform. The pressure sensor's alias (“WellheadPressure1”) is registered with the GDS. A new sensor with improved accuracy and a wider pressure range is installed. The new sensor registers the same alias (“WellheadPressure1”) with the GDS. The OPC UA client subscribes concurrently to both the old and new sensors, initially ignoring data from the new sensor. After the new sensor's readings are validated (e.g., by comparing readings to a secondary pressure sensor and checking for stability over time), and the temperature of the new sensor is within an acceptable operating range, the old sensor's registration is removed from the GDS. The client seamlessly transitions to the new sensor's data, ensuring uninterrupted monitoring of wellhead pressure and preventing potential safety hazards due to data loss.

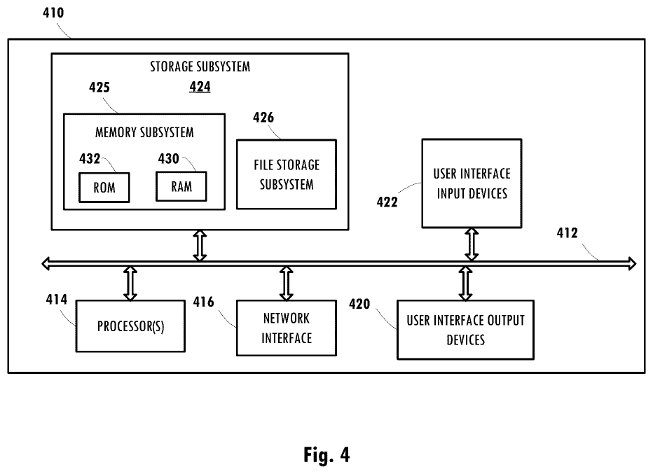

FIG. 4 is a block diagram of an example computing device 410, which may be used to implement selected aspects of process automation management system 102, such as a DCN, alias pub/sub module 107, GDS 104, and/or database 105. For example, computing device 410 implementing alias pub/sub module 107 and/or GDS 104 may be present within process automation management system 102. Computing device 410 typically includes at least one processor 414 which communicates with a number of peripheral devices via bus subsystem 412, and/or alias pub/sub module 107. These peripheral devices may include a storage subsystem 424, including, for example, a memory subsystem 426 and a file storage subsystem 428, user interface input devices 422, user interface output devices 420, and a network interface subsystem 416. The input and output devices allow user interaction with computing device 410. Network interface subsystem 416 provides an interface to outside networks and is coupled to corresponding interface devices in other computing devices.

User interface input devices 422 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computing device 410 or onto a communication network.

User interface output devices 420 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computing device 410 to the user or to another machine or computing device.

Storage subsystem 424 stores programming and data constructs that provide the functionality of some or all of the modules described herein. For example, the storage subsystem 424 may include the logic to perform selected aspects of the method 300, described herein.

These software modules are generally executed by processor 414 alone or in combination with other processors. Memory 426 used in the storage subsystem 424 can include a number of memories including a main random access memory (RAM) 430 for storage of instructions and data during program execution and a read only memory (ROM) 432 in which fixed instructions are stored. A file storage subsystem 428 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 428 in the storage subsystem 424, or in other machines accessible by the processor(s) 414.

Bus subsystem 412 provides a mechanism for letting the various components and subsystems of computing device 410 communicate with each other as intended. Although bus subsystem 412 is shown schematically as a single bus, alternative implementations of the bus subsystem may use multiple busses.

Computing device 410 can be of varying types including a workstation, server, computing cluster, blade server, server farm, or any other data processing system or computing device. Due to the ever-changing nature of computers and networks, the description of computing device 410 depicted in FIG. 4 is intended only as a specific example for purposes of illustrating some implementations. Many other configurations of computing device 410 are possible having more or fewer components than the computing device depicted in FIG. 4.

In some implementations, a method implemented by processor(s) is provided and includes identifying an alias registered to multiple nodes of a process automation facility, each node including a sensor or actuator. The method includes using the alias, concurrently subscribing to first and second nodes of the multiple nodes. While concurrently subscribed to both the first and second nodes, and while a first criterion is satisfied, the method includes exchanging data with the first and second nodes. The method further includes, based on the data exchanged with the first node, contributing to a process control loop of the process automation facility. The method further includes disregarding data received from the second node. Upon determining that the first criterion is no longer satisfied or that a second criterion is satisfied, the method includes exchanging data with at least the second node. The method further includes, based on the data exchanged with the second node, contributing to the same process control loop or a different process control loop of the process automation facility.

In some implementations, the first criterion can be that the first node was subscribed to prior to the second node. In some of those implementations, the first criterion can be that the first node is assigned a higher priority than the second node. In some versions of those implementations, the first criterion can be that the alias remains registered to the first node. In some implementations, the second criterion can be a halt in data received from the first node. In some of those implementations, the second criterion can be a degradation in data quality of data received from the first node. In some versions of those implementations, the second criterion can be a degradation of a network connection with the first node. In some of those implementations, the second criterion can be the alias having been migrated from the first node to the second node. In some versions of those implementations, the second criterion can be the alias having been deregistered by an alias server. In some of those implementations, the second criterion can be a determination that the second node satisfies one or more performance metrics. In some implementations, the first and second nodes can be first and second sensors. In some of those implementations, contributing to the process control loop can include operating one or more actuators based on one or more sensor signals from the first and second sensors.

In some implementations, the methods described above may be carried out by a system comprising one or more processors and transitory and/or non-transitory computer-readable media storing instructions executable by the processors. These instructions cause the processors to perform the steps of the methods, such as identifying aliases, concurrently subscribing to nodes, exchanging data, contributing to process control loops, and transitioning between data sources based on predefined criteria. The system may include components such as an OPC UA client or server, a Global Discovery Server (GDS), and a database for storing alias information. The computer-readable media may be any suitable storage medium, including RAM, ROM, hard disk drives, solid-state drives, or other non-volatile memory.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

What is claimed is:

1. A method implemented using one or more processors and comprising:
identifying an alias registered to multiple nodes of a process automation facility, each node comprising a sensor or actuator;
using the alias, concurrently subscribing to first and second nodes of the multiple nodes;
while concurrently subscribed to both the first and second nodes, and while a first criterion is satisfied:
exchanging data with the first and second nodes,
based on the data exchanged with the first node, contributing to a process control loop of the process automation facility, and
disregarding data received from the second node; and
upon determining that the first criterion is no longer satisfied or that a second criterion is satisfied:
exchanging data with at least the second node, and
based on the data exchanged with the second node, contributing to the same process control loop or a different process control loop of the process automation facility.

2. The method of claim 1, wherein the first criterion comprises the first node being subscribed to prior to the second node.

3. The method of claim 1, wherein the first criterion comprises the first node being assigned a higher priority than the second node.

4. The method of claim 1, wherein the first criterion comprises the alias remaining registered to the first node.

5. The method of claim 1, wherein the second criterion comprises a halt in data received from the first node.

6. The method of claim 1, wherein the second criterion comprises a degradation in data quality of data received from the first node.

7. The method of claim 1, wherein the second criterion comprises a degradation of a network connection with the first node.

8. The method of claim 1, wherein the second criterion comprises the alias having been migrated from the first node to the second node or the alias having been deregistered by an alias server.

9. The method of claim 1, wherein the second criterion comprises a determination that the second node satisfies one or more performance metrics.

10. The method of claim 1, wherein the first and second nodes comprise first and second sensors.

11. The method of claim 10, wherein contributing to the process control loop comprises operating one or more actuators based on one or more sensor signals from the first and second sensors.

12. A system comprising one or more processors and memory storing instructions that, in response to execution by the one or more processors, cause the one or more processors to:
identify an alias registered to multiple nodes of a process automation facility, each node comprising a sensor or actuator;
using the alias, concurrently subscribe to first and second nodes of the multiple nodes;
while concurrently subscribed to both the first and second nodes, and while a first criterion is satisfied:
exchange data with the first and second nodes,
based on the data exchanged with the first node, contribute to a process control loop of the process automation facility, and
disregard data received from the second node; and
upon determining that the first criterion is no longer satisfied or that a second criterion is satisfied:
exchange data with at least the second node, and
based on the data exchanged with the second node, contribute to the same process control loop or a different process control loop of the process automation facility.

13. The system of claim 12, wherein the first criterion comprises the first node being subscribed to prior to the second node.

14. The system of claim 12, wherein the first criterion comprises the first node being assigned a higher priority than the second node.

15. The system of claim 12, wherein the first criterion comprises the alias remaining registered to the first node.

16. The system of claim 12, wherein the second criterion comprises a halt in data received from the first node.

17. The system of claim 12, wherein the second criterion comprises a degradation in data quality of data received from the first node or a degradation of a network connection with the first node.

18. The system of claim 12, wherein the second criterion comprises a determination that the second node satisfies one or more performance metrics.

19. The system of claim 12, wherein the second criterion comprises the alias having been migrated from the first node to the second node.

20. At least one non-transitory computer-readable medium comprising instructions that, in response to execution of the instructions by one or more processors, cause the one or more processors to:
identify an alias registered to multiple nodes of a process automation facility, each node comprising a sensor or actuator;
using the alias, concurrently subscribe to first and second nodes of the multiple nodes;
while concurrently subscribed to both the first and second nodes, and while a first criterion is satisfied:
exchange data with the first and second nodes,
based on the data exchanged with the first node, contribute to a process control loop of the process automation facility, and
disregard data received from the second node; and
upon determining that the first criterion is no longer satisfied or that a second criterion is satisfied:
exchange data with at least the second node, and
based on the data exchanged with the second node, contribute to the same process control loop or a different process control loop of the process automation facility.
